(19) United States
(12) Patent Application Publication
(10) Pub. No.: US 2020/0061887 A1
(43) Pub. Date: Feb. 27, 2020

(54) HOLLOW PROFILE COMPOSITE TECHNOLOGY

(71) Applicant: LANXESS DEUTSCHLAND GMBH, Köln (DE)

(72) Inventor: Boris KOCH, Wermelskirchen (DE)

(73) Assignee: LANXESS DEUTSCHLAND GMBH, Köln (DE)

(21) Appl. No.: 16/463,173

(22) PCT Filed: Dec. 18, 2017
(86) PCT No.: PCT/EP2017/083190

§ 371 Date: May 22, 2019

(30) Foreign Application Priority Data
Dec. 23, 2016 (EP) 16206664.1
Jul. 25, 2017 (EP) 17182929.4

(51) Int. Cl. B29C 45/14

(52) U.S. Cl. CPC B29C 45/1418; B29C 45/72; B29C 45/14836; B29C 45/14598

(57) ABSTRACT

The invention relates to a process for producing a composite component from at least one hollow profile base structure and at least one support element positioned in the interior of the at least one hollow profile base structure.

The invention relates to a process for producing a composite component from at least one hollow profile base structure and at least one support element positioned in the interior of the at least one hollow profile base structure.

Even now, there are many cases of use of composite components in motor vehicle construction. They are usually produced from a metallic tubular profile and a metallic closed hollow profile that are bonded to at least one separately produced plastics element. The production of two separate components and finally the bonding leads to an elevated level of manufacturing and assembly complexity. For bonding of the tubular profile or hollow profile to the plastics element(s), additional bonding means in the form of screws, nuts, rivets or the like are required, which generally requires more construction space and leads to higher weight of the composite component.

Comparable composite components consisting of plastic alone—i.e. both hollow profile and plastics element are made of plastic—given acceptable dimensions of the cross sections, show lower strengths and stiffnesses, but also disadvantages in the absorption of energy under abrupt stress, compared to equivalent components made of metallic materials.

WO 2004/091999 A1 discloses a cavity composite component consisting of a hollow profile and of a one-part or multipart support element, the support element being bonded to the hollow profile in the form-fitting manner by means of thermoplastic and the form-fitting being effected by plastic deformation of at least one part of the hollow profile in the application of the thermoplastic by injection molding.

WO 2006/102047 A1 describes a bonding method in which one component is first inserted into a second component in an overlapping manner, then the first component is widened by an additional method such that the necessary gap for insertion of the two components has been eliminated, in order then, in a third step, to bond the two components to one another in a fixed manner with in a further process step.

GB 2350655 A describes a bonding method for bonding of two motor vehicle frame segments in which the injection pressure of the plastics material to be applied results in radial indentation of the two ends of the two tubular segments that are directed toward one another and, after solidification of the plastics material, the segments are bonded to one another in a fixed manner and, at the same time, rotation thereof with respect to one another is no longer possible.

DE 100 14 332 A1 describes a composite component and a process for production thereof by applying a plastics element by injection molding at various sites on a hollow profile base structure preferably produced by means of hydroforming in order to partly or completely ensheath it.

WO 2008/067901 A1 discloses a process for producing a composite component, wherein a tubular metallic hollow profile is formed in a widening manner to a final form by means of a fluidic hydroforming method.

DE B 1232332 describes a process and an apparatus for molding an outer ring bulge onto an elastically deformable tube made of plastic.

DE 10 2005 051 687 A1 teaches a structure component made of plastic and a process for production thereof, in which the structure component as base matrix includes a plastic with inset stiffening element, wherein the stiffening element is bonded in a form-fitting and/or force-fitting manner to the plastics matrix and the stiffening element is connected to the plastics matrix by means of an adhesion promoter.

DE 10 2014 019 724 A1 describes a process for producing structural elements composed of functional element and fiber-plastic-composite hollow profile, in which, through a selective sequence of the insertion of a shaping element and the inlaying of a semifinished structural element, local heating of the fiber-plastic-composite hollow profile is conducted in the region of the undercut of the contour-imparting element.

DE 10 2014 014 296 A1 discloses a hollow profile component made of continuous fiber-reinforced thermoplastic with a load introduction site for the stiffening thereof on the outside of a component wall section a reinforcing element made of a short fiber-reinforced plastic has been applied by injection molding.

EP 0 370 342 A2 describes a lightweight component in which a dish-shaped base structure has reinforcing fins in its interior, the bonding of which to the base structure in dish form is effected via discrete connection sites via passages in the base structure, through which the plastic extends and across the areas of the passages.

WO 2009/077026 A1 describes a process for producing a composite component from a profile and an injection-molded element, wherein the injection-molded element is molded onto the profile, such that the profile is captively gripped in peripheral direction, and wherein at least one form-fitting element is formed in the profile and is included in the injection-molding operation in that the form-fitting element between the ends of the profile is shaped or molded in a restricted manner in terms of peripheral direction and longitudinal extent.

The disadvantage of the solution indicated in WO 2009/077026 A1 lies firstly in a very complex and costly process and secondly in the considerable restriction, as a result of the process, in the configuration options for the mechanical bonds between the injection-molded plastics component and the profile.

According to WO 2009/077026 A1, first of all, in a combination mold, a hydroforming method is employed, before an injection molding method is employed to apply the injection-molded elements. The combination of these two processes that takes place in succession, first hydroforming then injection molding, in a common mold results in a limitation in the minimal dimension of the wall thickness of the profile, which is a barrier to a reduction in weight for the purposes of modern lightweight construction. In addition, restrictions arise in the configuration of the bonding site between the two components that ultimately leads to a distinct reduction in shear resistance and shear stiffness of the bond of injection-molded component to the profile—also called hollow profile hereinafter. Since the bonding in WO 2009/077026 A1 is based on a form fit between the two components, this can only be executed by means of insert molding around the profile in the form of a ring, referred to in WO 2009/077026 A1 as circumferential lamella. However, the breadth of such a circumferential lamella is limited and can be only a few millimeters since there can otherwise be unwanted high deformation of the hollow profile wall during the hydroforming process, extending as far as bursting of the hollow profile wall. A rise in the bond stiffness or bond strength of hollow profile and injection-molded component can therefore be effected according to WO 2009/077026 A1 only by means of an arrangement of multiple circumferential lamellae of this kind across the profile. A minimum distance of a few millimeters of width has to be observed here between two circumferential lamellae. This distance is generated by cores in the mold. When the breadth of these cores is too small, there is in turn the risk of core fracture and of bursting of the hollow profile since, in the hydroforming of the tube, the tube wall is both radially widened and moved axially on the engraved pattern, and the hollow profile has to be supported over a maximal area. According to WO 2009/077026 A1, it is therefore possible, for a profile area X of 100%, to coat only an average proportion of 50% at most with plastic by overmolding.

It is therefore an object of the present invention to provide a plastic/hollow profile composite technology for production of composite components, with which thin-wall hollow profiles with injection-molded or compressed plastics structures can be bonded to one another to give stiff and mechanically durable components by the injection molding or compression process on the industrial scale.

“Thin-wall” in the context of the present invention preferably means a ratio of diameter of a hollow profile to the wall thickness thereof in the range from 5:1 to 300:1.

Moreover, composite components to be produced in accordance with the invention should not have the abovementioned disadvantages in terms of manufacture or disadvantages in terms of strength and stiffness properties, and also in terms of energy absorption characteristics, and should permit a high degree of functional integration for the purposes of system or module formulation in economically viable manufacture.

### INVENTION

The object is achieved by a process for producing a composite component by
a) providing at least one support element,
b) providing at least one hollow profile base structure having a ratio of diameter to wall thickness in the range from 5:1 to 300:1,
c) introducing and positioning the at least one support element within the at least one hollow profile base structure at the positions where plastic is applied outside the hollow profile base structure, and fixing thereof,
d) compressing the hollow profile base structure, preferably solely in the region of the at least one support element positioned within the hollow profile base structure, by the action of external forces on the hollow profile base structure outer wall by means of a compression mold with reduction in the outer dimension of the hollow profile base structure by a range from 0.5% to 5% based on the original outer dimension thereof viewed in compression direction,
e) inserting the hollow profile base structure containing at least one support element into a cavity of an injection mold or compression mold,
f) closing the injection mold or compression mold and locally compressing the hollow profile base structure in closure direction of the injection mold or compression mold at the position(s) where the axial ends of the at least one support element positioned in the hollow profile base structure are present,
g) externally applying plastic in the form of a melt to the hollow profile base structure in a locally limited manner in the region of the at least one support element positioned in the hollow profile base structure, and deforming the hollow profile base structure by means of the injection or compression pressure solely in the region of the at least one support element positioned in the hollow profile base structure,
h) cooling the plastics melt applied to the hollow profile base structure in g) (solidification), and
i) removing the finished composite component from the injection mold.

Compression in process steps d), e) and f) means deformation in which no circumferential extension is brought about, but merely a change in shape. In the event of a tolerance-related excess size of the hollow profile base structure circumference, a change in shape is likewise preferably brought about, but in that case there is again a minor reduction in circumference toward the end of the mold closure movement.

Surprisingly, the process of the invention permits the production of composite components in which a hollow profile base structure has been bonded to an externally applied plastics component in a form-fitting, shear-resistant and shear-stiff manner, in that, of an outer area section of the hollow profile base structure of X=100%, more than 50%, preferably 75% to 100%, more preferably 90% to 100%, is bonded to plastic, preferably by injection molding application, insert molding, overmolding, compression application or insert compression molding.

The present invention therefore also relates to a composite component comprising at least one base structure having hollow profile cross section—hollow profile base structure hereinafter—and at least one plastics element bonded to said hollow profile base structure in a form-fitting manner at discrete bonding sites, and at least one support element positioned within the hollow profile base structure at the discrete bonding sites of the at least one plastics element applied to the outside, and the hollow profile base structure has a diameter/wall thickness ratio in the range from 5:1 to 300:1.

In one embodiment, the present invention relates to a composite component obtainable by
a) providing at least one support element,
b) providing at least one hollow profile base structure having a ratio of diameter to wall thickness in the range from 5:1 to 300:1,
c) introducing and positioning the at least one support element within the at least one hollow profile base structure at the positions where plastic is applied outside the hollow profile base structure, and fixing thereof,
d) compressing the hollow profile base structure, preferably solely in the region of the at least one support element positioned within the hollow profile base structure, by the action of external forces on the hollow profile base structure outer wall by means of a compression mold with reduction in the outer dimension of the hollow profile base structure by a range from 0.5% to 5% based on the original outer dimension thereof viewed in compression direction,
e) inserting the hollow profile base structure containing at least one support element into a cavity of an injection mold or compression mold,
f) closing the injection mold or compression mold and locally compressing the hollow profile base structure in closure direction of the injection mold or compression mold at the position(s) where the axial ends of the at least one support element positioned in the hollow profile base structure are present,
g) externally applying plastic in the form of a melt to the hollow profile base structure in a locally limited manner in the region of the at least one support element positioned in the hollow profile base structure, and deforming the hollow profile base structure by means of the injection or compression pressure solely in the region of the at least one support element positioned in the hollow profile base structure,
h) cooling the plastics melt applied to the hollow profile base structure in g) (solidification), and
i) removing the finished composite component from the injection mold.

Although it is necessary in accordance with the invention to produce support elements in an upstream step, these—since they are positioned within the at least one hollow profile base structure—do not require any additional construction space. The presence of the support element(s) can therefore at first mean an added weight for the end product—the composite component—but lead to a lower weight at the end of the process, especially when it is therefore possible to use hollow profile base structures having the lower wall thicknesses, or else support element(s) are removed again from the hollow profile base structure by subsequent removal, especially by melting.

According to the invention, the form or structuring of the wall of the hollow profile base structure that arises in the process of the invention and hence the wall of the bonding surface of the two components of the composite component is defined/controlled via the configuration of the at least one support element. The result is a form-fitting bond/interdigitation of hollow profile base structure and plastic applied by injection molding with the blocking of all degrees of freedom, by translation in X, Y and Z direction and by rotation about the X, Y and Z axis, and hence a shear-resistant and shear-stiff connection at least in axial direction, preferably in axial and radial direction, based on the hollow profile base structure.

If, after process step i), the at least one support element is removed from the interior of the hollow profile base structure in an additional process step j), in one embodiment of the present invention, composite components are obtained without support element(s).

For clarification, it should be noted that all definitions and parameters adduced, mentioned in general terms or within ranges of preference, are encompassed in any and all combinations. Standards cited in the context of this application are considered to mean the version in force at the filing date. Shear strength is a physical constant that describes the resistance offered by a material to being sheared away, i.e. to separation by forces that attempt to move two adjoining faces in the longitudinal direction.

Shear strength is determined by the shear modulus, also called modulus of rigidity. In the context of the present invention, “bonded to one another in a shear-resistant manner” means a form-fitting bond of the hollow profile base structure to at least one plastics element applied to the hollow profile base structure, said bond being shear-resistant in axial direction, preferably in axial and radial direction, of the hollow profile base structure.

Shear stiffness is the product of the shear modulus G of a material and the cross-sectional area A:

Shear stiffness=G·A·κ(=G·Aₛ)

The cross section-dependent correction factor K takes account of the inhomogeneous distribution of shear stress T over the cross section. Shear stress is often also expressed in terms of the shear area Aₛ. See: https://de.wikipedia.org/wiki/Steifigkeit.

Form-fitting bonds in the context of the present invention arise through the intermeshing of at least two bonding partners that enter into an inextricable bond with one another and can only be separated from one another by destruction. See: https://de.wikipedia.org/wiki/Verbindungstechnik.

### Preferred Embodiments of the Invention

In a preferred or alternative embodiment, during or after process step c), at least one bead, preferably multiple beads, is/are introduced from the outside into the wall of the hollow profile base structure in the region of the at least one support element, preferably exactly at the position of the at least one support element.

In a preferred or alternative embodiment, before or during process step b), at least one hole, preferably multiple holes, is/are introduced from the outside into the wall of the hollow profile base structure in the region of the at least one support element, preferably exactly at the position of the at least one support element.

In a preferred or alternative embodiment, during or after process step c), at least one hole, preferably multiple holes, is/are introduced from the outside into the wall of the hollow profile base structure in the region of the at least one support element, preferably exactly at the position of the at least one support element.

In these three latter embodiments, there is no longer any need for deformation of the wall of the hollow profile base structure via the injection pressure as described in process step g) in order to generate a form-fitting, shear-resistant and shear-stiff bond in at least axial direction of the hollow profile base structure, preferably in axial and radial direction of the hollow profile base structure, between the hollow profile base structure and the application of plastic, preferably the application of plastic by injection molding or the application of plastic by compression molding.

In a further preferred or alternative embodiment, after process step d) and before process step e), at least one plastics melt volume is deposited in at least one cavity intended for this purpose in the injection mold or compression mold and, in process step f), the plastics melt volume is compressed locally by closure of the injection mold or compression mold and pressed from the outside against the wall of the hollow profile base structure and simultaneously against the at least one support element positioned on the hollow profile base structure, or compressed around the hollow profile base structure.

In a further preferred or alternative embodiment, after process step i), in the case of a metallic hollow profile base structure, an additional hydroforming process (HF) is employed to change the shape of the hollow profile base structure at the positions where there is no support element and also no application of plastic. See: https://de.wikipedia.org/wiki/Innenhochdruckumformen.

In a further preferred or alternative embodiment, after process step i), in the case of a hollow profile base structure made of plastic, an additional blow-molding process is employed to change the shape of the hollow profile base structure at the positions where there is no support element and also no application of plastic.

In a further preferred or alternative embodiment, after process step i), the hollow profile base structure is deformed at at least one position by the action of additional flexural forces at positions where there is no support element and also no application of plastic. Preferably, it is possible to allow additional bending forces to act when the final composite component shape differs from that of a straight hollow profile base structure.

In a further preferred or alternative embodiment, the bond of hollow profile base structure and plastic applied by injection molding is additionally assisted by the blocking of all degrees of freedom, by translation in X, Y and Z direction and by rotation about the X, Y and Z axis, by means of a surface treatment of the outer wall of the hollow profile base structure. This surface treatment is preferably effected before at least one of process steps b), c), d) and e).

Preferred forms of surface treatment are the application of at least one adhesion promoter, plasma surface activation, laser structuring, chemical pretreatment or an additive application process.

Preferred means of chemical pretreatment are the use of acids or bases. A preferred additive application process is the thermal metal spray application process. See: https://de.wikipedia.org/wiki/Thermisches_Spritzen.

### Process Step A)

In process step a), at least one support element is provided.

A factor of the utmost importance for the establishment of the bond between the thin-wall hollow profile base structure and the plastics component to be applied by means of injection molding or compression in process step g) is the at least one support element to be provided in process step a) and its particular form or configuration. The at least one support element to be provided in process step a) serves primarily for internal support of the thin hollow profile wall.

Without the use of at least one support element, the thin-wall hollow profile base structure for use in accordance with the invention would be collapsed by the spray pressure or compression pressure in the injection molding process or compression process. A support element for use in accordance with the invention must be in a form or configuration adapted to the internal cross section of the hollow profile base structure to be used. Since the person skilled in the art, on account of the later function of the composite component, is aware of the shape and configuration of the hollow profile base structure to be used, the person skilled in the art will provide correspondingly suitable support elements in process step a).

In the design, the material and other configuration features of the at least one support element to be provided in process step a), the person skilled in the art will be guided by the three functions of a support element:
1. Support elements to be used must support the hollow profile base structure wall against collapse of the hollow profile cross section during the application of plastic in process step g) and in the region of the plastic applied;
2. Support elements to be used are effectively the negative mold for forming regions of the hollow profile base structure wall in the region of the plastic to be applied in process step g);
3. If appropriate, support elements to be used serve as supports for the surfaces of the hollow profile base structure wall at the position(s) where the axial ends of the at least one support element positioned in the hollow profile base structure are present, and serve for sealing of the cavity of the plastic to be applied. According to the material of the hollow profile base structure wall, however, even the inherent supporting action thereof may be sufficient.

The at least one support element to be provided in process step a) also serves as a counter-bearing to a structured wall of a hollow profile base structure which is produced by the injection or compression pressure of the plastics component.

The at least one support element should preferably be positioned exactly at the site in the interior of the hollow profile base structure where the plastics component is applied to the outer wall of the hollow profile base structure in process step g). This application is preferably effected by injection molding application, by insert molding, by compression application or by insert compression molding.

A support element for use in accordance with the invention is preferably configured such that it
1. permits compression of the hollow profile base structure in process step d) by the action of external force through a compression mold, preferably at an angle in the range from 45° to 135°, on the hollow profile base structure outer wall with reduction of the outer dimension of the hollow profile base structure in the direction of the pressing operation by a range from 0.5% to 5%, such that resistance-free and collision-free insertion of the hollow profile into the injection mold or compression mold is possible, and the at least one support element in the hollow profile is fixed;
2. permits bending of the hollow profile base structure and at the same time supports the hollow profile base structure in such a way that it does not buckle during bending;
3. builds up a sufficient backpressure during the closing of the injection mold or the compression mold and ensures sealing of the injection mold cavity;
   optionally at the same time supports the surfaces of the hollow profile base structure wall at the position(s) where the axial ends of the at least one support element positioned in the hollow profile base structure are present, and those serve to seal the cavity of the plastic applied, if the intrinsic supporting action of the hollow profile base structure wall is insufficient;
4. ensures sufficient stability of the thin-wall hollow profile base structure during the operation of injection of the thermoplastic and prevents collapse of the cross section of the hollow profile base structure, preferably of the tubular cross section of the hollow profile base structure (main function);
5. has such a structure that local deformations of the thin-wall hollow profile can be achieved via the injection pressure or compression pressure of the thermoplastic melt or by means of a preceding compression operation with solid rams;
6. generates a deformation as described in 5. in such a way that, ultimately, the application of the plastics component to the outer wall of the hollow profile base structure, preferably in the form of injection molding application, insert molding, compression molding application or insert compression molding, together with the plastics components, results in a stiff, highly durable and permanently stable form-fitting bond between hollow profile base structure and the plastics component; and
7. has a minimum weight in the range from 1 to 1000 g and is inexpensive if the support element remains in the hollow profile after process step i).

In the preferred case that the hollow profile base structure has the shape of a tube or tubular form, at least one cylindrical support element is preferably positioned within the hollow profile base structure.

In the case that the process of the invention is combined together with an HF method, support elements with a continuous hole that enables the flow of a fluid being used in an HF method through the at least one support element should preferably be used in process step a). In the case of a tubular hollow profile base structure, particular preference is given to cylindrical support elements with a bore along the axis thereof, called hollow cylinders.

A support element for use in accordance with the invention can be produced by various methods and consist of various materials. For production of support elements for use in accordance with the invention, preference is given to employing the techniques of die cutting, deep drawing, insertion, welding, soldering, riveting, casting, compression casting or injection molding.

Preference is given to producing support elements for use in accordance with the invention using at least one material from the group of metals, thermoplastics, thermosets and ceramic. Preferred metals are steel, aluminum, magnesium, titanium, tin, bismuth, brass or other alloys.

Particular preference is given to producing the at least one support element to be provided in process step a) from a thermoplastic. The thermoplastic used is more preferably a polyamide or a polyester. The polyamide used is preferably a nylon-6. The polyester used is preferably a polyalkylene terephthalate, more preferably polybutylene terephthalate.

Most preferably, the at least one support element is produced from a thermoplastic with at least one filler or reinforcer. Preference is given to using glass fibers as filler or reinforcer. Especially preferably, 0.1 to 85 parts by mass of filler or reinforcer are used per 100 parts by mass of the thermoplastic. Support elements to be used in accordance with the invention that are based on thermoplastics are produced in a step preceding the process according to the invention, preferably by injection molding.

Especially preferably, support elements for use in accordance with the invention are produced from a glass fiber-reinforced nylon-6 with 15 to 60 parts by mass of glass fibers per 100 parts by mass of polyamide by an injection molding process.

If the support element(s) is/are to be removed from the composite component again after production thereof, these are melted out in a further process step j) after process step i) has ended. In this case, preference is given to using low-melting metals or alloys that withstand the process of the invention, but can then be liquefied by higher temperatures, preferably by the action of temperatures in the range from 80 to 220° C., and removed again from the hollow profile base structure. A support element to be used for this purpose consists of a metal or an alloy having a melting point below the melting point of the plastic to be used in process step g). Preference is given to using tin-bismuth alloys. DE 4124021 C2 discloses a tin-bismuth alloy having a melting point of 138° C.

Support elements to be used in accordance with the invention that are based on thermoplastics are produced in a step preceding the process according to the invention by injection molding.

In one embodiment, the at least one support element may be a plastic-metal hybrid, preferably a cylindrical metal tube with plastics fins applied by injection molding. Plastic-metal hybrid technology is known to the person skilled in the art, for example, from EP 0 370 342 A1.

### Process Step B)

In process step b), at least one hollow profile base structure having a diameter/wall thickness ratio in the range from 5:1 to 300:1 is provided.

A hollow profile base structure for use in accordance with the invention can be produced by various methods, have various cross-sectional shapes and consist of various materials. Preferably, it is produced using at least one of the techniques of strand pressing, strand drawing, extrusion, blow molding, injection molding, seamless drawing, longitudinal welding, spiral welding, winding and pultrusion. The thin-wall hollow profile for use in accordance with the invention may have a circular, elliptical or polygonal—triangular, quadrangular, pentangular, . . . polyangular—cross section.

Preferably, a hollow profile base structure to be provided in process step b) has a wall thickness in the range from 0.1 and 10.0 mm. A hollow profile base structure for use in accordance with the invention preferably has at least two openings, one at each end.

Preference is given to producing hollow profile base structures for use in accordance with the invention using at least one material from the group of metals, alloys, thermoplastics and thermosets.

Preferred metals are steel, aluminum, magnesium, titanium, tin, zinc, lead, silver, gold, brass or alloys. Preferred thermoplastics are polyamides (PA), polybutylene terephthalate (PBT), polyethylene terephthalate (PET), polyethylene (PE), polypropylene (PP) and polyvinyl chloride (PVC). The thermoplastic used for a hollow profile base structure for use in accordance with the invention is more preferably polyamide or polyester. The polyamide used is preferably a nylon-6. The polyester used is preferably polybutylene terephthalate (PBT) or polyethylene terephthalate, especially PBT. Preferred thermosets are epoxy resins, crosslinkable polyurethanes or unsaturated polyester resins.

More preferably, the hollow profile base structure to be provided in process step b) is produced from a thermoplastic with at least one filler or reinforcer. Preference is given to using glass fibers as filler or reinforcer. Especially preferably, fillers or reinforcers are used in amounts in the range from 0.1 to 85 parts by mass per 100 parts by mass of the thermoplastic.

Especially preferred, in the case of plastic-based hollow profile base structures, are those produced from a glass fiber-reinforced nylon-6 with 15 to 60 parts by mass of glass fibers per 100 parts by mass of polyamide by an injection molding process.

In the case of metal-based hollow profile base structures, those used are especially preferably those made of aluminum or steel, especially made of steel.

Preference is given in accordance with the invention to using metal tubes in the form of a hollow cylinder as hollow profile base structure.

PA for use for the hollow profile base structure wall may be synthesized from different feedstocks and be produced by different methods and, in the specific application case, may be used alone or, in a manner known to those skilled in the art, modified to give materials having specifically adjusted combinations of properties. Also suitable are PA blends comprising proportions of other polymers, preferably of polyethylene, polypropylene, ABS, one or more compatibilizers being optionally employable. The properties of the polyamides can be improved if required by addition of elastomers.

A multitude of procedures for production of PA are known; depending on the desired end product, different monomer units or various chain transfer agents are used to establish a target molecular weight or else monomers having reactive groups for subsequently intended after treatments are used.

PA for use with preference is prepared by polycondensation in the melt; in the context of the present invention, the hydrolytic polymerization of lactams is also regarded as polycondensation.

PA to be used with preference in accordance with the invention for the hollow profile base structure wall is based on diamines and dicarboxylic acids and/or lactams having at least 5 ring atoms or corresponding amino acids. Useful reactants preferably include aliphatic and/or aromatic dicarboxylic acids, more preferably adipic acid, 2,2,4-trimethyladipic acid, 2,4,4-trimethyladipic acid, azelaic acid, sebacic acid, isophthalic acid, terephthalic acid, aliphatic and/or aromatic diamines, particularly preferably tetramethylenediamine, hexamethylenediamine, 1,9-nonanediamine, 2,2,4- and 2,4,4-trimethylhexamethylenediamine, the isomeric diem inodicyclohexylmethanes, diem inodicyclohexylpropanes, bisaminomethylcyclohexane, phenylenediamines, xylylenediamines, aminocarboxylic acids, especially aminocaproic acid, or the corresponding lactams. Copolyamides of a plurality of the monomers mentioned are included.

For the hollow profile base structure wall, particular preference is given to using PA made from lactams, very particular preference being given to using caprolactams, especially preferably ε-caprolactam.

Also usable in accordance with the invention is PA prepared by activated anionic polymerization or copolyamide prepared by activated anionic polymerization having polycaprolactam as the main constituent. Activated anionic polymerization of lactams to afford polyamides is performed on an industrial scale by preparing firstly a solution of catalyst in lactam, optionally together with impact modifier, and secondly a solution of activator in lactam, the two solutions typically having such a composition that combination in an equal ratio affords the desired overall recipe. Further additives may optionally be added to the lactam melt. Polymerization is effected by mixing the individual solutions to afford the overall recipe at temperatures in the range from 80° C. to 200° C., preferably at temperatures in the range from 100° C. to 140° C. Useful lactams include cyclic lactams having 6 to 12 carbon atoms, preferably laurolactam or ε-caprolactam, more preferably ε-caprolactam. The catalyst is an alkali metal or alkaline earth metal lactamate, preferably as a solution in lactam, more preferably sodium caprolactamate in ε-caprolactam. Activators used in the context of the invention may be N-acyllactams or acid chlorides or, preferably, aliphatic isocyanates, more preferably oligomers of hexamethylene diisocyanate. The activator used may be either the pure substance or preferably a solution, preferably in N-methylpyrrolidone.

Particularly suitable polyamides for the hollow profile base structure wall are those having a relative solution viscosity in m-cresol in the range from 2.0 to 4.0, preferably in the range from 2.2 to 3.5, very particularly in the range from 2.4 to 3.1. Relative solution viscosity ηᵣₑₗ is measured in accordance with EN ISO 307. The ratio of the outflow time t of the polyamide dissolved in m-cresol to the outflow time t(0) of the m-cresol solvent at 25° C. gives the relative solution viscosity by the formula ηᵣₑₗ=t/t(0).

Particularly suitable polyamides for the hollow profile base structure wall are additionally those having a number of amino end groups in the range from 25 to 90 mmol/kg, preferably in the range from 30 to 70 mmol/kg, very particularly in the range from 35 to 60 mmol/kg.

Very particular preference is given to using, for the hollow profile base structure wall, semicrystalline polyamides or compounds based thereon as matrix polymer. According to DE 10 2011 084 519 A1, semicrystalline polyamides have an enthalpy of fusion in the range from 4 to 25 J/g measured by the DSC method to ISO 11357 in the 2nd heating run and integration of the melt peak. In contrast, amorphous polyamides have an enthalpy of fusion of less than 4 J/g, measured by the DSC method to ISO 11357 in the 2nd heating run and integration of the melt peak.

According to the invention, PA for use for the hollow profile base structure wall is obtainable as PA6 [CAS No. 25038-54-4] or as PA66 [CAS No. 32131-17-2] from Lanxess Deutschland GmbH, Cologne, under the Durethan® name.

In one embodiment, at least PE is used as thermoplastic for the hollow profile base structure wall. Polyethylene [CAS No. 9002-88-4] is a semicrystalline and nonpolar thermoplastic. It is possible via the choice of polymerization conditions to adjust the molar mass, molar mass distribution, mean chain length and degree of branching. On the basis of the different density, a distinction is made between four main types, although the abbreviations are not always used uniformly:
high-density polyethylene, PE-HD or HDPE
medium-density polyethylene, PE-MD or MDPE
low-density polyethylene, PE-LD or LDPE
linear low-density polyethylene, PE-LLD or LLDPE.
   Very particular preference is given in accordance with the invention to HDPE or LDPE.

In one embodiment, at least PP is used as thermoplastic for the hollow profile base structure wall. PP [CAS No. 9003-07-0] is a semicrystalline thermoplastic and forms part of the group of the polyolefins. Polypropylene is obtained by polymerization of the monomer propene with the aid of catalysts.

In one embodiment, at least PC is used as thermoplastic for the hollow profile base structure wall. Particular preference is given to using polycarbonates based on 2,2-bis(4-hydroxyphenyl)propane (bisphenol A), bis(4-hydroxyphenyl) sulfone (bisphenol S), dihydroxydiphenyl sulfide, tetramethylbisphenol A, 1,1-bis(4-hydroxyphenyl)-3,3,5-trimethylcyclohexane (BPTMC) or 1,1,1-tris(4-hydroxyphenyl)ethane (THPE). The use of PC based on bisphenol A is especially preferred. PC for use in accordance with the invention is available, for example, under the Makrolon® name from Covestro AG, Leverkusen.

In one embodiment, at least PBT [CAS No. 24968-12-5] is used as thermoplastic for the hollow profile base structure wall. PBT forms through polycondensation of the bis(4-hydroxybutyl) terephthalate intermediate. The latter can be prepared by esterification of butane-1,4-diol and terephthalic acid or by catalytic transesterification of dimethyl terephthalate with butane-1,4-diol in the presence of transesterification catalysts, for example tetraisopropyl titanate. PBT for use with particular preference contains at least 80 mol %, preferably at least 90 mol %, based on the dicarboxylic acid, of terephthalic acid residues and at least 80 mol %, preferably at least 90 mol %, based on the diol component, of butane-1,4-diol glycol residues. PBT for use in accordance with the invention is available, for example, under the Pocan® name from Lanxess Deutschland GmbH, Cologne.

In one embodiment, at least PET is used as thermoplastic for the hollow profile base structure wall. PET [CAS No. 25038-59-9] is a thermoplastic polymer, prepared by polycondensation, from the family of the polyesters based on the monomers ethylene glycol and terephthalic acid. PET for use with particular preference contains at least 80 mol %, preferably at least 90 mol %, based on the dicarboxylic acid, of terephthalic acid residues and at least 80 mol %, preferably at least 90 mol %, based on the diol component, of ethylene glycol residues.

In one embodiment, PVC [CAS No. 9002-86-2] is used as thermoplastic for the hollow profile base structure wall. Being an amorphous thermoplastic, PVC is hard and brittle and is only made soft, formable and suitable for industrial applications by addition of plasticizers and stabilizers. PVC is known for its use in floor coverings, for window profiles, pipes, for cable insulation and sheathing, and for records. Preference is given in accordance with the invention to using rigid PVC (PVC-U) as typically used for pipes and profiles. Rigid PVC tubes as hollow profile base structures are available, for example, from ThyssenKrupp Plastics Germany, Cologne.

### Process Step C)

In process step c), the introduction and exact positioning of the at least one support element within the at least one hollow profile base structure is effected at the positions where plastic will be applied in process step g). More particularly, process step c) is effected with the proviso that the circumference of the hollow profile base structure does not undergo any widening. For this purpose, preference is given to using support elements having an outer dimension or outer cross-sectional shape congruent to the inner dimension or inner cross-sectional shape of the hollow profile base structure.

“Congruent” in process step c) means that the shape and dimensions of the outwardly directed faces of a support element correspond as far as possible to the shape and dimensions of the inwardly directed faces of a hollow profile base structure for use in accordance with the invention. As a result, the inner face of a hollow profile base structure for use in accordance with the invention and the outer face of a support element for use in accordance with the invention preferably have about equal distances from one another along their common contact surface(s). Preference is given to support elements which, in terms of their outlines as well, correspond as far as possible on all sides to the inner shape of a hollow profile base structure for use in accordance with the invention and at the same time have a roughly congruent structure to the inner wall of the hollow profile base structure.

Preferably, the congruence relates to the inner dimension or the inner cross-sectional shape of the at least one hollow profile base structure provided in b).

Roughly equal distances mean manufacturing tolerance-related deviations in congruence in the range from −1.5% to +3% between the outer dimension or the outer cross-sectional shape of a support element and the inner dimension or the inner cross-sectional shape of a hollow profile base structure for use in accordance with the invention.

Various procedures for introduction of the at least one support element are conceivable here. Preferably, all support elements are pushed or inserted together or else individually in succession into the hollow profile base structure, preferably into the metal tube. After the introduction and positioning of the at least one support element in the hollow profile base structure, this is/these are fixed in the positions to be determined beforehand by the person skilled in the art on the basis of future load events in the interior of the hollow profile base structure by forming of the hollow profile base structure to a narrower shape in process step c), for which the person skilled in the art will use a compression method.

In one embodiment, by additional local forming, preferably by means of one or more beads, the fixing of the at least one support element and hence the fixing of the later plastic/hollow profile bond is undertaken.

### Process Step D)

In process step d), the hollow profile base structure is compressed by the action of external forces on the hollow profile base structure outer wall by a compression mold with reduction of the outer dimension of the hollow profile base structure by a range from 0.5% to 5% based on the original outer dimension thereof viewed in compression direction. The outer circumference of the hollow profile base structure remains the same in this operation, but the outer dimension thereof in the direction of the compression operation is reduced by the forming by the stated range from 0.5% to 5%.

Preferably, the hollow profile base structure is compressed in the region of the at least one support element positioned in the hollow profile base structure or in the region of the support elements positioned in the hollow profile base structure.

Preferably, the compression is effected by the action of a compression mold on the outer wall of the hollow profile base structure at an angle in the range from 45° to 135° based on the insertion direction of the hollow profile base structure into an injection mold or compression mold.

More preferably, the compression mold acts at an angle in the range from 70° to 110°, especially at an angle of 90°, on the outer wall of the hollow profile base structure. The hollow profile base structure is compressed to such a degree that resistance-free and collision-free insertion of the hollow profile base structure into the injection mold or compression mold is possible. The compression fixes support elements positioned within the hollow profile base structure in the region of the application of plastic effected in process step g). For the force to be applied for compression by means of a compression mold, pressures to be applied are those that deform the wall of the hollow profile base structure but do not damage or destroy the support elements positioned within it. What is crucial, therefore, is the selection of a suitable material for the hollow profile base structure wall and a hollow profile base structure shape that permits sufficient elongation before the at least one support element breaks, but nevertheless sufficiently supports the hollow profile base structure from the inside.

### Process Step E)

In process step e), the hollow profile base structure compressed in process step c) is inserted into a cavity of an injection mold or compression mold. As well as the hollow profile base structure lightly compressed in process step d), therefore, the configuration of the injection mold or compression mold is likewise important in order that the process of the invention, especially the insertion and sealing of the injection molding or compression molding cavity, works without difficulty. By contrast with the prior art, the hollow profile base structure is inserted into the cavity without widening thereof. The join between the hollow profile base structure and the cavity of the mold that adjoins the hollow profile base structure section provided with application of plastic is sealed solely via change in shape of the circumference of the hollow profile base structure, while the circumference itself remains the same.

In the case of use of hollow profile base structures with round circumference, there is preferably a change in shape to an ellipse. In the case of use of hollow profile base structures with elliptical circumference, there is preferably a change in shape to a round circumference.

Preferably, the ratio of the circumference of the hollow profile base structure to the inner circumference of the mold cavity of the mold is in the range from 1:1 to 1.1:1. It is extremely surprising to the person skilled in the art that, even in the case of a tolerance-related excess size of the circumference of the hollow profile base structure compared to the inner circumference of the mold cavity, the gap or join is closed reliably and hence sealed for the injection molding operation, and excess material resulting from tolerance-related oversize is not injected into the separation planes of the injection mold. This property of the process of the invention, the change in shape of the hollow profile base structure with the closing of the mold, and hence the simultaneous sealing of the mold cavity with respect to the hollow profile base structure outer surface permits the directly subsequent and locally limited application of plastic on the hollow profile, represented here as process step g) and hence, by comparison with the prior art, without any need for an additional process step, resulting in distinctly shortened cycle times.

Preferably, the injection mold or compression mold for use in accordance with the invention and also the hollow profile base structure for use in accordance with the invention have the following features in order that the latter with all its dimensional and shape tolerances can be inserted without force into the respective mold:
A. The injection mold or compression mold has to be such that it seals the injection molding or compression molding cavities with respect to the regions of the hollow profile base structure in which there is no application of plastic on closure of the mold. For this purpose, contact surfaces in the mold are needed at the axial ends of the injection molding or compression molding cavities in the injection mold or compression mold, which compress the hollow profile base structure during the closing of the mold to its original shape that existed prior to process step d) against the support element introduced in process step c).
B. In one embodiment, the contact surfaces of the at least two mold halves, with respect to the hollow profile base structure in the injection mold or compression mold, are executed such that the hollow profile base structure, over and above the compression described in A., is additionally compressed to its original shape that existed prior to process step d) by a range from 0.01% to 1%.
C. The contact surfaces of the at least two mold halves in the injection mold or compression mold that have been mentioned in A. and B., with the mold closed, enclose the hollow profile base structure over its entire extent and preferably have a width, i.e. an extent viewed in axial direction of the hollow profile base structure, in the range from 1.0 to 10.0 mm.
D. In one embodiment, the contact surfaces of the at least two mold halves with respect to the hollow profile base structure in the injection mold or compression mold are executed such that these regions in the mold are constituted by hardened inserts.
E. The mold has to offer a clear space around the hollow profile base structure between its contact surfaces outside the injection molding or compression molding cavities. This clear space is preferably in the range from 1.0 to 10.0 mm.

The hardened inserts being used in D. preferably have a Rockwell hardness in the range from 50 to 62 HRC. The hardness is thus within the region of customary bending and punching tools. See: https://de.wikipedia.org/wiki/Rockwell_(Einheit).

### Process Step F)

In process step f), the injection mold or compression mold is closed and the hollow profile base structure is compressed in closure direction at the contact surfaces described in process step e) at the side of the injection molding or compression molding cavity/cavities, and hence the injection molding or compression molding cavity is/cavities are sealed.

During the closing of the injection mold or compression mold, at the position(s) where the axial ends of at least one support element are present, there is gentle pressing of the hollow profile base structure against the at least one support element, and the shape of the hollow profile base structure that has been lightly compressed in process step d) is returned to its original shape that existed prior to process step d).

By means of the contact surfaces described in process step e) in the mold, the hollow profile base structure in process step f) is clearly kept within the cavity of the injection mold or compression mold, and the cavities in the hollow profile that are provided for the injection molding or for the compression are sealed.

When the mold closes, a compression force is required in order to press the hollow profile base structure back into its original shape, as is a closure force for the injection molding process in order to seal the cavity. The level of the compression force is guided by the shape of the at least one hollow profile base structure provided in process step b) and by the shape of the at least one support element provided in process step a). Moreover, the shape, dimensions and material properties of the hollow profile base structure and support element (1) are crucial for the pre-calculation of the compression force to be applied, which has to be taken into account by the person skilled in the art in the design of the process according to the invention.

The level of the closure force of the mold is guided by the projected area of the plastic insert moldings or plastic compression moldings intended by application of plastic, and the injection forces that are required to inject or to compress the corresponding plastics in process step g).

In one embodiment, the compression force to be applied is below the closure force of the injection molding process.

### Process Step G)

In process step g), plastic is locally applied in the form of a melt to the outer wall of the hollow profile base structure solely in the region of the at least one support element positioned in the hollow profile base structure, and deforming the hollow profile base structure by means of the injection or compression pressure solely in the region of the at least one support element positioned in the hollow profile base structure. The deformation is a direct consequence of the injection pressure or compression pressure applied. The extent of the deformation depends on the level of the pressure and the wall thickness, and on the wall material of the hollow profile, and also on the configuration of the at least one support element positioned within the hollow profile base structure (size of the wall area not supported by the support element). In the case of multiple support elements of the same type, and provided that the pressure is sufficiently high and virtually the same across the hollow profile support body, the same deformation can be established across the entire hollow profile base structure. The shape limitation for the deformation is defined by the support element.

The pressures, temperatures and volumes to be applied in process step g) are dependent on the plastics materials used and the geometry of the cavity/cavities to be filled with plastic, which have to be taken into account in advance by the person skilled in the art in the design of the process of the invention.

The compression of the hollow profile base structure by means of the mold contact surfaces described in process step e) during the closing of the injection mold or compression mold achieves sealing against escape of the plastics melt to be applied in g) between the plastic overmolding and the non-overmolded regions of the hollow profile in the mold cavity. In one embodiment, the tool contact surfaces are executed in such a way that these regions in the mold are constituted by hardened inserts.

The execution of hardened mold inserts described in process step e) under point D. serves, in process step g), to reduce the wear on the mold contact surfaces since these are the only contact sites between injection mold or compression mold and hollow profile base structure and the hardened mold inserts have distinctly higher hardness than the material of the hollow profile base structure.

During the local application of plastic to the hollow profile base structure in process step g), the at least one support element within the hollow profile base structure builds up a sufficient opposing pressure to the pressure generated by the mold contact surfaces on the outer wall of the hollow profile base structure, and hence seals the mold contact surfaces or the cavity against any escape of plastics material.

The application of plastic to the at least one hollow profile base structure in process step g) is preferably effected by injection molding or flow molding.

### Injection Molding

According to DIN 8580, the manufacturing methods are divided into 6 main groups. Injection molding is assigned to main group 2, primary forming. It is especially suitable for mass-produced articles since the raw material is converted to a finished part in usually one operation. Reworking is minor or can be dispensed with entirely, and even complicated shapes and outlines can be manufactured in one operation. Injection molding as a manufacturing method in plastics processing is known in principle to those skilled in the art; see https://de.wikipedia.org/wiki/Spritzgie%C3%9Fen.

In injection molding, an injection molding machine is used to liquefy (plastify) the plastic to be processed and inject it into a mold, the injection mold, under pressure. In the mold, the material is converted back to the solid state as a result of cooling or as a result of crosslinking reaction and, after the opening of the mold, is removed as a finished part. It is the cavity of the mold that determines the shape and surface structure of the solidified application of plastic in the composite component. Nowadays, products in the weight range from a few tenths of a gram up to an order of magnitude of 150 kg are producible by injection molding.

Injection molding, especially extended specific methods, permits a virtually free choice of shape and surface structure, for example smooth surfaces, grains for touch-friendly regions, patterns, engravings and color effects. Together with economic viability, this makes injection molding the most commonly used process for mass production of plastic parts in virtually all sectors.

An injection molding apparatus comprises at least the following components: 1. screw 2. intake funnel 3. pellets 4. plastifying barrel 5. heating elements 6. mold.

The following steps are effected within an injection molding apparatus: 1. plastifying and metering, 2. injecting, 3. maintaining hold pressure and cooling, and 4. demolding.

### 1. Plastifying and Metering

The thermoplastic trickles into the flights of a rotating screw in the form of a granular material. The granular material is conveyed in the direction of the screw tip and is heated and melted by the heat of the barrel and the heat of friction that arises in the division and shearing of the material. The melt collects in front of the screw tip since the exit nozzle is closed at first. Since the screw is axially movable, it retracts as a result of the pressure, and also screws out of the material like a corkscrew. The backward motion is attenuated by a hydraulic cylinder or by electrical means, such that a backpressure builds up in the melt. This backpressure in conjunction with the screw rotation compresses and homogenizes the plastic to be injected as injection molding material.
The screw position is measured and, as soon as an amount of injection molding material sufficient for the workpiece volume has collected, the metering operation has ended and the screw rotation is stopped. The stress on the screw is likewise actively or passively released, such that the melt is decompressed.

### 2. Injecting

In the injection phase, the injection unit is moved to the closure unit, the exit nozzle is pressed against it and the screw is put under pressure on the reverse side. This forces the melt under high pressure, preferably at a pressure in the range from 500 to 2000 bar, through the opened exit nozzle and the runner or runner system of the injection mold into the shaping cavity. A nonreturn barrier prevents backflow of the melt in the intake funnel direction.
During the injection, an attempt is made to achieve very substantially laminar flow characteristics of the melt. This means that the melt is immediately cooled in the mold when it touches the cooled mold wall and “sticks” in solidified form. The subsequent melt is forced through the resultant narrowing melt channel at even higher velocity and with even more shear deformation and is subjected to expansive deformation at the melt front toward the edge. Removal of heat via the mold wall occurs concurrently with supply of heat through shear heating. The high injection rate produces a shear velocity in the melt that allows the melt to flow more easily. Rapid injection is not the aim since the high shear velocity also increases molecular degradation within the plastic. The surface of the product, the appearance thereof and ultimately the state of orientation of the plastic molecules are also affected by the injection phase.

### 3. Maintaining Hold Pressure and Cooling

Since the mold is colder than the plastic material, the mold preferably having a temperature in the range from 20 to 120° C. and the plastic material preferably having a temperature in the range from 200 to 300° C., the melt cools down in the mold and solidifies on attainment of the solidification point of the particular plastic used, preferably of the thermoplastic or thermoplastic-based compound. The cooling is associated with a volume shrinkage that has an adverse effect on trueness to scale and surface quality of the product to be manufactured, in the present invention the form-fittingly bonded plastics element that is to be manufactured in process step g). In order to partly compensate for this shrinkage, even after the filling of the mold, a reduced pressure is also maintained in order that further plastic material can flow in and compensate for the shrinkage. This hold pressure can be maintained until the sprue has solidified.
After the hold pressure phase has ended, the exit nozzle can be closed and the plastifying and metering operation for the next molding can already commence in the injection unit. The plastics material in the mold cools down further in the residual cooling time until the center, the liquid core of the workpiece, has solidified and achieved a stiffness sufficient for demolding. This operation is also referred to as solidification and, according to the invention, proceeds in process step h).
The injection unit can then be moved away from the closure unit since no plastic can escape from the sprue any longer. The purpose of this is to prevent transfer of heat from the warmer exit nozzle to the colder sprue.

### 4. Demolding

For demolding in the inventive process step i), the ejector side of the closure unit is opened and the workpiece is ejected by means of pins that project into the cavity and either falls out (bulk material) or is removed from the mold by handling devices and laid down in an orderly manner or sent straight to further processing.
The sprue either has to be removed by separate processing or is automatically severed in the demolding operation. Sprueless injection molding is also possible with hot runner systems in which the runner system remains constantly above the solidification temperature of the plastic used, preferably thermoplastic, thermoset or compound, and the material present can thus be used for the next shot.

### Flow Molding

According to DIN 8583, flow molding is one type of pressure forming, and hence is likewise part of the family of forming methods. Flow molding is a bulk forming method that creates either hollow bodies or solid bodies by a one-stage or multistage manufacturing operation.

See: https://de.wikipedia.org/wiki/Flie%C3%9pressen.

In principle, in this process, the material is made to flow under the action of a high pressure. A ram here forces the raw material through a shaping mold opening of reduced cross section—a die.

According to the material and component shape, the forming is effected at semi-warm or warm room temperature. In that case, reference is respectively made to cold flow molding (cold forming), semi-warm flow molding or warm flow molding (hot forming). Particularly in the case of cold forming, high dimensional accuracy and surface quality is achieved in the component to be created. In the case of thermoplastics, reference is made to warm flow molding; in the case of use of thermosets, reference is made to cold flow molding or semi-warm flow molding.

If large-scale forming is required or the material generally allow only a very minor change in shape, the raw part is heated prior to forming. Dimensional accuracy here is lower, and the surfaces are rough due to scale formation (reworking required).

Flow molding methods with rigid molds are divided, according to flow direction, into:
Forward flow molding: flow molding with material flow in the working direction of the machine;
Backward flow molding: flow molding with material flow counter to the working direction of the machine. The material thus flows not through the die but through the gap between ram and (closed) die—counter to the ram movement (in the reverse direction along the ram);
Transverse flow molding: flow molding with material flow transverse to the working direction of the machine;

A combination of these three flow molding methods is possible.

In addition, a distinction is made as to whether solid, hollow or dish-shaped parts are produced in the process. The designation would then change as follows: solid forward flow molding, hollow forward flow molding or dish forward flow molding.

In addition, there are also flow molding methods with active media (e.g. HF=hydroforming). This includes hydrostatic flow molding. This is a forward flow molding method in which the ram does not press directly onto the workpiece; instead, a liquid surrounds the workpiece. The pressure required, preferably in the range from 15 000 to 20 000 bar, is achieved by means of a pump or press.

### Plastics

Plastics to be used in the inventive injection molding or flow molding method of application of plastic in process step g) are preferably thermoplastics or thermosets, more preferably thermoplastics.

Preferred thermoplastics are polyamides (PA), polybutylene terephthalate (PBT), polyethylene terephthalate (PET), polyethylene (PE), polypropylene (PP) and polyvinyl chloride (PVC). The thermoplastic used for a hollow profile base structure for use in accordance with the invention is more preferably polyamide or polyester. The polyamide used is preferably a nylon-6. The polyester used is preferably polybutylene terephthalate (PBT) or polyethylene terephthalate, especially PBT. Preferred thermosets are epoxy resins, crosslinkable polyurethanes or unsaturated polyester resins.

The thermoplastic or thermoset is preferably used in the form of a compound. Compounding is a term from the plastics industry that describes the upgrading of plastics by mixing in admixtures, preferably fillers, additives etc., for achievement of desired profiles of properties. Compounding is preferably effected in extruders, particularly preferably in co-rotating twin-screw extruders, counter-rotating twin-screw extruders, and by planetary gear extruders or co-kneaders, and comprises the process operations of conveying, melting, dispersing, mixing, degassing and pressure buildup; see: https://de.wikipedia.org/wiki/Compoundierung. A compound therefore refers to a thermoplastic or thermoset with added fillers or additives.

More preferably, the application of plastic to be provided in process step g) is produced from a thermoplastic with at least one filler or reinforcer. Preference is given to using glass fibers as filler or reinforcer. Especially preferably, fillers or reinforcers are used in amounts in the range from 0.1 to 85 parts by mass per 100 parts by mass of the thermoplastic. Very particular preference is given to using glass fibers as filler or reinforcer. Especially preferably, fillers or reinforcers are used in amounts in the range from 15 to 60 parts by mass per 100 parts by mass of the thermoplastic.

Especially preferably, an application of plastic composed of a glass fiber-reinforced nylon-6 with 15 to 60 parts by mass of glass fibers per 100 parts by mass of polyamide is used in the injection molding process.

Alternatively, the melt of a plastic to be applied in process step g) can also be produced from a thermoset. In this case, preference is given to using epoxy resins, crosslinkable polyurethanes and unsaturated polyester resins.

Particular preference is given to the application of a plastic in process step g) with a thermoset with at least one filler or reinforcer. Preferably, the filler or reinforcer used in this case is glass fibers or carbon fibers.

Especially preferably, 10 to 50 parts by mass of glass fibers or carbon fibers as filler or reinforcer are used per 100 parts by mass of the thermoset.

According to the spatial configuration of the at least one support element positioned within the at least one hollow profile base structure, according to the dimension of the wall thickness of the hollow profile base structure and according to the choice of material of the hollow profile base structure, in one embodiment of the present invention, in process step g), the injection pressure of the injection molding operation or compression pressure of the flow molding operation can give rise to local deformations, preferably beads, on the thin wall of the hollow profile base structure. These deformations or beads can have an additional positive effect on the strength of the bond of hollow profile base structure to the plastics element to be applied to the outside of the hollow profile base structure.

The extent of deformation of local deformations achieved in process step g) on the hollow profile base structure, preferably in the form of beads, on the hollow profile base structure wall, in one embodiment of the present invention, is limited by the elongation at break of the respective material of the hollow profile base structure. If this is exceeded, the hollow profile base structure wall can break. However, the elongation can be limited by regulation of the injection or compression pressure, or else by the shape of the negative mold of the support element, by way of a distance/deformation limitation that does not permit, or limits, excessively large deformation, i.e. expansion of the material. The deformation is likewise dependent on the material composition and thickness of the hollow profile base structure wall.

The greater the extent of deformation of the hollow profile base structure wall, the greater the intermeshing of the at least two bonding partners—hollow profile base structure and plastics component applied, and the more they enter into an inextricable form-fitting bond that can be parted again only by destruction. The aim of this process step g) should therefore be to exploit the extensibility of the respective material of the hollow profile base structure wall to the maximum degree, but not to exceed the elongation at break.

In the case of thermoplastic as material for the hollow profile base structure or the hollow profile base structure wall, local heating of the hollow profile base structure can take place at least exactly at the position(s) where the local application of plastic in the form of a melt to the hollow profile base structure takes place solely in the region of the at least one support element positioned in the hollow profile base structure. This measure can increase the elongation at break of the material.

### Process Step H)

In process step h), the plastics overmolding is cooled down, which is also referred to as solidification. The term “solidification” describes the hardening of the molten plastic applied in process step g) as a result of cooling or chemical crosslinking to give a solid body. In the case of simultaneous shaping, it is possible in this way to directly apply functional elements, structures and surfaces to the hollow profile base structure.

In one embodiment of the present invention and in the case of the beads described in process step g), after the solidification of the plastics melt on the outer surface of the hollow profile base structure, preferably a metal tube, the result is a continuous plastics ring having a structured inner surface that exactly constitutes the positive image of the bead structure of the outer wall of the hollow profile base structure, preferably the metal tube.

A shear-resistant, shear-stiff, highly durable and form-fitting bond around the outer wall of the hollow profile base structure, preferably around the outer wall of a metal tube, is the result.

Further details of process step h) have already been described above under “Maintaining hold pressure and cooling”.

### Process Step I)

In process step i), the finished composite part is removed from the injection mold since, with solidification of the plastics melt, the pressure in the application of plastic is no longer present and the compression force and closure force has been dissipated with the opening of the mold. Further details have already been described above under Demolding.

### Composite Component

Composite components to be produced in accordance with the invention are used in corresponding configuration preferably for motor vehicle construction, especially in automobile construction. These are preferably bodywork parts, especially a cross car beam (CCB), also referred to as dash panel. Dash panels are known, for example, from U.S. Pat. No. 5,934,744 A or U.S. Pat. No. 8,534,739 B.

In the composite component of the invention, the hollow profile base structure and the plastics elements supplied by means of a plastics melt in process step g) stiffen and reinforce one another. Moreover, the plastics elements applied to the outer wall of the hollow profile base structure in process step g) additionally serve for integration of function for the purposes of system or module formation for attachment of plastics structures or plastics surfaces.

Preferred embodiments of a composite component to be produced in accordance with the invention have either beads or similar deformations and/or bores or similar openings in the hollow profile base structure.

The invention therefore preferably relates to a composite component in which the wall of the hollow profile base structure in the region of the at least one support element and the at least one plastics element has beads or similar deformations.

The invention additionally preferably relates to a composite component in which the wall of the hollow profile base structure in the region of the at least one support element and the at least one plastics element has bores or similar openings.

The invention additionally preferably relates to a composite component in which the wall of the hollow profile base structure in the region of the at least one support element and the at least one plastics element has beads or similar deformations and bores or similar openings.

The present invention additionally relates to a composite component obtainable by
a) providing at least one support element,
b) providing at least one hollow profile base structure having a ratio of diameter to wall thickness in the range from 5:1 to 300:1,
c) introducing and positioning the at least one support element within the at least one hollow profile base structure at the positions where plastic is applied outside the hollow profile base structure, and fixing thereof,
d) compressing the hollow profile base structure, preferably solely in the region of the at least one support element positioned within the hollow profile base structure, by the action of external forces on the hollow profile base structure outer wall by means of a compression mold with reduction in the outer dimension of the hollow profile base structure by a range from 0.5% to 5% based on the original outer dimension thereof viewed in compression direction,
e) inserting the hollow profile base structure containing at least one support element into a cavity of an injection mold or compression mold,
f) closing the injection mold or compression mold and locally compressing the hollow profile base structure in closure direction of the injection mold or compression mold at the position(s) where the axial ends of the at least one support element positioned in the hollow profile base structure are present,
g) externally applying plastic in the form of a melt to the hollow profile base structure in a locally limited manner in the region of the at least one support element positioned in the hollow profile base structure, and deforming the hollow profile base structure by means of the injection or compression pressure solely in the region of the at least one support element positioned in the hollow profile base structure,
h) cooling the plastics melt applied to the hollow profile base structure in g) (solidification), and
i) removing the finished composite component from the injection mold.

Preferably, in process step b), a hollow profile base structure made of metal is provided.

Particularly preferred embodiments are described below:

### Embodiment 1

Composite component composed of a hollow profile base structure and at least one plastics element, wherein the hollow profile base structure has at least one support element which is positioned within the hollow profile base structure which is positioned at the site where the plastics element partly or fully encompasses the hollow profile base structure, and the hollow profile base structure has beads or similar deformations between the at least one support element and the at least one plastics element.

### Embodiment 2

Composite component composed of a hollow profile base structure and at least one plastics element, wherein the hollow profile base structure has at least one support element which is positioned within the hollow profile base structure which is positioned at the site where the plastics element partly or fully encompasses the hollow profile base structure, and the hollow profile base structure has bores or similar openings through which plastic has been injected between the at least one support element and the at least one plastics element.

### Embodiment 3

Composite component composed of a hollow profile base structure and at least one plastics element, wherein the hollow profile base structure has at least one support element which is positioned within the hollow profile base structure which is positioned at the site where the plastics element partly or fully encompasses the hollow profile base structure, and the hollow profile base structure has beads or similar deformations and bores or similar openings through which plastic has been injected between the at least one support element and the at least one plastics element.

If the at least one support element is removed from the interior of the hollow profile base structure in a downstream process step j), what are obtained are corresponding composite parts composed of a hollow profile base structure and at least one plastics element form-fittingly bonded thereto in a shear-resistant and shear-stiff manner according to at least one of the above embodiments 1 to 3, except without support element(s).

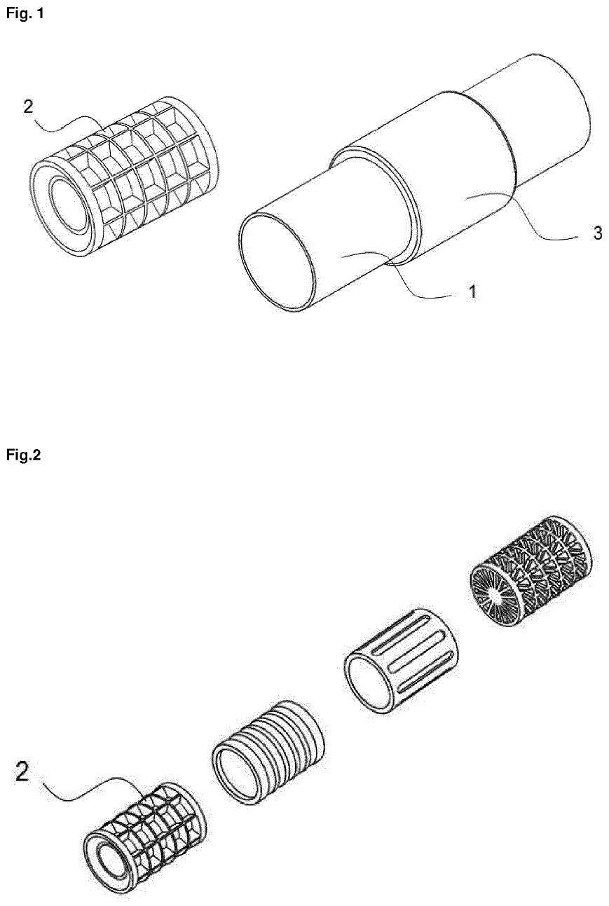

The present invention is elucidated by FIG. 1 to FIG. 5:

FIG. 1 shows the essential constituents of a composite part of the invention, in which 1 represents the hollow profile base structure, here in the embodiment of a tube, 2 represents a support element fitted by way of example in accordance with the inner tube diameter, and 3 represents a plastics element form-fittingly bonded to the hollow profile base structure.

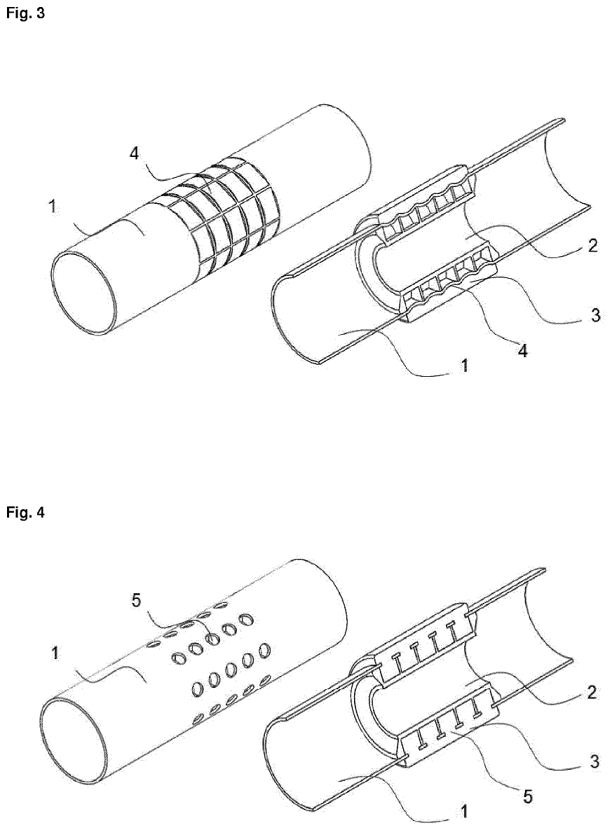

FIG. 2 shows variations of support elements 2 in cylinder form that are positioned within a hollow profile base structure in the form of a tube. The support elements shown here have a top-to-bottom opening, which means that these support elements enable the flow of the fluid to be used in an HF process which is optionally to be employed in addition through the support element.

FIG. 3 firstly shows a composite component of the invention as per the above- described embodiment 1, in which the wall of the hollow profile base structure 1 has structuring defined by the structure of the support element 2 with beads 4 which, secondly, as shown by the further diagram with a closed hollow profile base structure, remain even after mechanical removal of the plastics element 3 within the hollow profile base structure 1.

FIG. 4 shows an alternative embodiment to FIG. 3 of a hollow profile base structure 1 in the form of a tube with a multitude of bores 5, and, in a cutaway diagram, a support element 2 fixed to the outer wall of the hollow profile base structure by application of plastic 3, in that the plastic enters defined regions of the support element 2 through the bores and hardens or solidifies therein. FIG. 4 is thus a composite component as per the above-described embodiment 2.

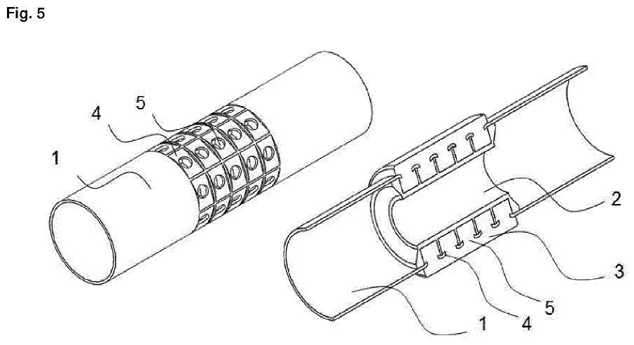

FIG. 5 shows an inventive composite component as per the above-described embodiment 3, in which the hollow profile base structure 1 has both a multitude of beads 4 and a multitude of bores 5.

1. A process for producing a composite component by
a) providing at least one support element,
b) providing at least one hollow profile base structure having a ratio of diameter to wall thickness in the range from 5:1 to 300:1,
c) introducing and positioning the at least one support element within the at least one hollow profile base structure at the positions where plastic is applied outside the hollow profile base structure, and fixing thereof,
d) compressing the hollow profile base structure by the action of external forces on the hollow profile base structure outer wall by means of a compression mold with reduction in the outer dimension of the hollow profile base structure by a range from 0.5% to 5% to a narrower shape based on the original outer dimension thereof viewed in compression direction,
e) inserting the hollow profile base structure containing at least one support element into a cavity of an injection mold or compression mold,
f) closing the injection mold or compression mold and locally compressing the hollow profile base structure in closure direction of the injection mold or compression mold at the position(s) where the axial ends of the at least one support element positioned in the hollow profile base structure are present,
g) externally applying plastic in the form of a melt to the hollow profile base structure in a locally limited manner in the region of the at least one support element positioned in the hollow profile base structure, and deforming the hollow profile base structure by means of the injection or compression pressure solely in the region of the at least one support element positioned in the hollow profile base structure,
h) cooling the plastics melt applied to the hollow profile base structure in g), and i) removing the finished composite component from the injection mold.

2. The process as claimed in claim 1, wherein, during or after process step c), at least one bead, optionally multiple beads, is/are introduced from the outside into the wall of the hollow profile base structure in the region of the at least one support element.

3. The process as claimed in claim 1, wherein, before or during process step b), at least one hole is additionally introduced from the outside into the wall of the hollow profile base structure in the region of the at least one support element.

4. The process as claimed in claim 1, wherein, during or after process step c), at least one hole is introduced from the outside into the wall of the hollow profile base structure in the region of the at least one support element.

5. The process as claimed in claim 1, wherein the compression in process step d) is effected by the action of a compression mold on the outer wall of the hollow profile base structure at an angle in the range from 45° to 135° based on the insertion direction of the hollow profile base structure into an injection mold or compression mold.

6. The process as claimed in claim 1, wherein, after process step d) and before process e), at least one plastics melt volume is deposited in at least one cavity intended for this purpose in the injection mold or compression mold and, in process step f), the plastics melt volume is compressed locally by closure of the injection mold or compression mold and pressed from the outside against the wall of the hollow profile base structure and simultaneously against the at least one support element positioned in the hollow profile base structure, or compressed around the hollow profile base structure.

7. The process as claimed in claim 1, wherein, after process step i), in the case of a metallic hollow profile base structure, an additional hydroforming process is employed to change the shape of the hollow profile base structure at the positions where there is no support element and also no application of plastic.

8. The process as claimed in claim 1, wherein, after process step i), in the case of a hollow profile base structure made of plastic, an additional blow-molding process is employed to change the shape of the hollow profile base structure at the positions where there is no support element and also no application of plastic.

9. The process as claimed in claim 1, wherein, after process step i), the hollow profile base structure is deformed at at least one position by the action of additional flexural forces at the positions where there is no support element and also no application of plastic.

10. The process as claimed in claim 1, wherein the bond of hollow profile base structure and plastic applied by injection molding is additionally assisted by the blocking of all degrees of freedom, by translation in X, Y and Z direction and by rotation about the X, Y and Z axis, by means of a surface treatment of the outer wall of the hollow profile base structure.

11. The process as claimed in claim 10, wherein the surface treatment precedes at least one of process steps b), c), d) and e)

12. The process as claimed in claim 1, wherein the compression in process step d) is effected solely in the region of the at least one support element positioned in the hollow profile base structure or in the region of the support elements positioned in the hollow profile base structure.

13. A composite component, which has at least one base structure having hollow profile cross section and at least one plastics element bonded to said hollow profile base structure in a form-fitting manner at discrete bonding sites, and at least one support element positioned within the hollow profile base structure at the discrete bonding sites of the at least one plastics element applied to the outside, and the ratio of diameter to wall thickness of the hollow profile base structure is in the range from 5:1 to 300:1.

14. The composite component as claimed in claim 13, wherein the wall of the hollow profile base structure in the region of the at least one support element and the at least one plastics element has beads or similar deformations.

15. The composite component as claimed in claim 13, wherein the wall of the hollow profile base structure in the region of the at least one support element and the at least one plastics element has bores or similar openings.

16. The composite component as claimed in claim 13, wherein the wall of the hollow profile base structure in the region of the at least one support element and the at least one plastics element has beads or similar deformations and bores or similar openings.

17. Method of using a composite component as claimed in claim 13, in motor vehicle construction, optionally in automobile construction.

18. A composite component obtainable by
a) providing at least one support element,
b) providing at least one hollow profile base structure having a ratio of diameter to wall thickness in the range from 5:1 to 300:1,
c) introducing and positioning the at least one support element within the at least one hollow profile base structure at the positions where plastic is applied outside the hollow profile base structure, and fixing thereof,
d) compressing the hollow profile base structure, optionally solely in the region of the at least one support element positioned within the hollow profile base structure, by the action of external forces on the hollow profile base structure outer wall by means of a compression mold with reduction in the outer dimension of the hollow profile base structure by a range from 0.5% to 5% based on the original outer dimension thereof viewed in compression direction,
e) inserting the hollow profile base structure containing at least one support element into a cavity of an injection mold or compression mold,
f) closing the injection mold or compression mold and locally compressing the hollow profile base structure in closure direction of the injection mold or compression mold at the position(s) where the axial ends of the at least one support element positioned in the hollow profile base structure are present,
g) externally applying plastic in the form of a melt to the hollow profile base structure in a locally limited manner in the region of the at least one support element positioned in the hollow profile base structure, and deforming the hollow profile base structure by means of the injection or compression pressure solely in the region of the at least one support element positioned in the hollow profile base structure,
h) cooling the plastics melt applied to the hollow profile base structure in g) (solidification), and
i) removing the finished composite component from the injection mold.
